(19) United States
(12) Patent Application Publication
(10) Pub. No.: US 2002/0168291 A1
(43) Pub. Date: Nov. 14, 2002

(54) Agent for health inspection and health inspection apparatus using the same

(75) Inventors: Takatoshi Kinoshita, Aichi (JP); Shintaro Washizu, Shizuoka (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/103,833

(22) Filed: Mar. 25, 2002

(30) Foreign Application Priority Data
Mar. 23, 2001 (JP) 2001-86316

(51) Int. Cl. G01N 21/01

(52) U.S. Cl. 422/59; 422/55; 422/58; 422/82.01; 422/82.05; 422/99; 436/165; 204/400; 204/403.1; 435/287.1; 435/287.2; 435/288.1; 435/288.7

(57) ABSTRACT

The agent for health inspection of the present invention is used as additive to a specimen solution and comprises a rod-shaped body and a capturing structured element bonded to the rod-shaped body which specifically captures a disease marker in the specimen solution.

### BACKGROUND OF THE INVENTION

1. Field of the Invention

The present invention relates to an agent for health inspection by which a person's state of health may easily be checked in a bathroom and the like at the person's own house and also to a health inspection apparatus using the same.

2. Description of the Related Art

Conventionally, for inspecting the health of human beings, there are various organizations and equipments available for conducting a periodical health examination, clinical survey, and the like for a person to have diagnosis of a certain portion of the body or various portions of the body, in order to find a disease at its early stage, or to confirm a state of being healthy, or to obtain advice in terms of what to be cautious about in a daily life, so as to make effective use of the result.

However, in such conventional methods for checking the state of health, problems arise in that, a person who wishes to have a health examination is required to visit a medical facility such as hospital, and moreover, result of such examination may not be available on the spot, and consequently the person has to wait a long time.

Even when vehicles furnished with examination equipments visit companies, schools, and the like to save a person from visiting medical facilities, the situation in which the person has to wait a long time before hearing the result of examination is unchanged. There is a problem in that if a person who waits a long time before the result to turn out catches a disease, it may become impossible to take any countermeasures to stop the progress of such disease.

### SUMMARY OF THE INVENTION

Under such circumstances, an object of the present invention is to overcome various conventional problems and to achieve the following object.

An object of the present invention is to provide an agent for health inspection with which it is possible for a person to conduct an examination in a daily life from excrements excreted as result of digestion of daily food taken in and nutritionally absorbed, without having to visit medical facility such as a hospital, and to provide a health inspection apparatus using the agent for health inspection which allows immediate informing of the result of examination, thus contributing to early discovery of diseases, or confirming a state of recovery from the diseases.

The agent for health inspection of the present invention is used as an additive to a specimen solution and comprises a rod-shaped body and a capturing structured element bonded to the rod-shaped body which specifically captures a disease marker in the specimen solution.

The agent for health inspection is used as an additive to the specimen and has a rod-shaped body and a capturing structured element bonded to the rod-shaped body, which specifically captures a disease marker contained in the specimen solution. As a result, it is now possible for a person to carry out an examination in a daily life without visiting medical facilities such as a hospital. Moreover, the results of the examination may be easily available on the spot whereby early discovery of the disease and state of the recovery from disease are easily available.

The first aspect of the health inspection apparatus of the present invention is that it has a rod-shaped body having a length of 810 nm or less and a capturing structured element specifically capturing, by bonding to the rod-shaped body, a disease marker contained in the specimen solution. The apparatus of the present invention also has an agent for health inspection reflecting an incident light as colored interference light by aligning in a film-like shape and is provided with an adding means for contacting the agent for health inspection to a sample to be examined and a wavelength measuring means for measuring the change in the wavelength brought out by the light reflection as colored interference light of the film-formed agent for health inspection which captures the disease marker.

The agent for health inspection aligned in a film-like shape reflects an incident light as colored interference light on the basis of a multi-layer thin film interference theory which is a basic principle for color formation of scaly powder of the wings of a Morpho butterfly. It is possible to examine the presence of the disease marker by measuring changes in wavelengths or refractive indices based on light reflectance as colored interference light caused by changes in lengths of the capturing structured element of the film like health inspection agent takes place.

The second aspect of the health inspection apparatus of the present invention is that it has a rod-shaped body and a capturing structured element bonding to the rod-shaped body, which specifically captures a disease marker contained in the specimen solution and is provided with a biosensor where an agent for health inspection which is amphiphilic is adhered and bonded in a film-like shape to a quartz oscillator or a surface acoustic wave (SAW) element, an oscillation circuit where a mass change or a viscoelasticity change when the disease marker is captured by the biosensor is oscillated as a frequency, and a frequency counter where the frequency of the oscillation oscillated from the oscillation circuit is measured.

As a result, changes in mass or changes in viscoelasticity when the capturing structured element of the agent for health inspection constituting the biosensor specifically captures the disease marker may be detected as specific frequencies under high sensitivity in a short time.

### BRIEF DESCRIPTION OF THE DRAWINGS

FIG. 1 is a schematic view of an agent for health inspection relating to one embodiment of the present invention.

FIG. 2 is a view for explaining a principle of light reflection of an incident light as colored interference light.

FIG. 3 is a typical view to explain the principle of light reflection of the incident light as colored interference light.

FIG. 4 is a schematic view for showing a formation of a monomolecular film by a functional molecule of the present invention.

FIG. 5 is a schematic view for showing an example of an amphiphilic functional molecule aligned on water (aqueous phase).

FIG. 6 is a schematic view for showing an example of an amphiphilic functional molecule vertically aligned on water (aqueous phase).

FIG. 7A and 7B are example views of a quartz oscillator in which FIG. 7A is a plan view and FIG. 7B is a front view.

FIG. 8 is a schematic view which shows an example of a health inspection apparatus.

FIG. 9 is a schematic plan view showing a surface acoustic wave (SAW) element.

### DESCRIPTION OF THE PREFERRED EMBODIMENTS

Hereinafter, the present invention will be described in more detail.

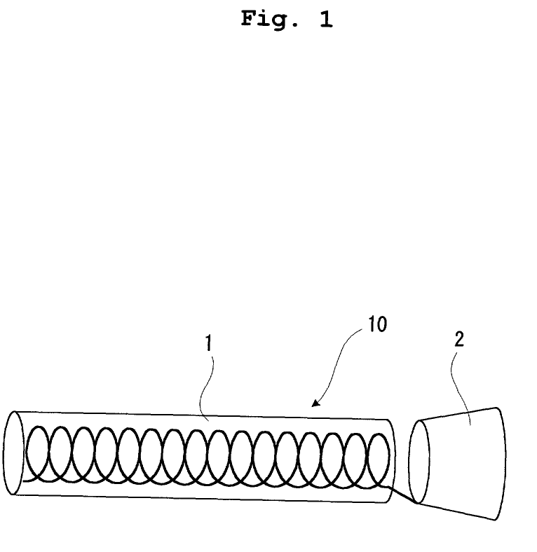

As shown as an example in FIG. 1, the agent for health inspection 10 of the present invention is used as an additive to a specimen and has a rod-shaped body 1 and a capturing structured element 2 which specifically captures, by bonding to the rod-shaped body, a disease marker contained in the specimen solution. Incidentally, in FIG. 1, the capturing structured element 2 is bonded to one end of the rod-shaped body 1. However, it may be also bonded to the circumferential side of the rod-shaped body 1 and, in that case, it is also possible to have a plural capturing structured element bonded to the circumferential side of the rod-shaped body.

### Rod-Shaped Body

The rod-shaped body is not particularly limited provided that it is rod-shaped, and may be appropriately selected in accordance with the object. The rod-shaped body may be either a rod-shaped inorganic substance or rod-shaped organic substance, but a rod-shaped organic substance is preferable.

Examples of rod-shaped organic substances are biopolymers, polysaccharides, and the like.

Suitable examples of biopolymers are fibrous proteins, α-helix polypeptides, nucleic acids (DNA, RNA), and the like. Examples of fibrous proteins are fibrous proteins having α-helix structures such as α-keratin, myosin, epidermin, fibrinogen, tropomyosin, silk fibroin, and the like. Suitable examples of polysaccharides are amylose and the like.

Among rod-shaped organic substances, spiral organic molecules whose molecules have a spiral structure are preferable from the standpoints of stable maintenance of the rod shape and internal intercalatability of other substances in accordance with an object. Among the aforementioned substances, those with spiral organic molecules include α-helix polypeptides, DNA, amylose, and the like.

### α-Helix Polypeptides

α-helix polypeptides are referred to as one of the secondary structures of polypeptides. The polypeptide rotates one time (forms one spiral) for each amino acid 3.6 residue, and a hydrogen bond, which is substantially parallel to the axis of the helix, is formed between a carbonyl group (—CO—) and an imide group (—NH—) of each fourth amino acid, and this structure is repeated in units of seven amino acids. In this way, the α-helix polypeptide has a structure which is stable energy-wise.

The direction of the spiral of the α-helix polypeptide is not particularly limited, and may be either wound right or wound left. Note that, in nature, only structures whose direction of spiral is wound right exist from the standpoint of stability.

The amino acids which form the α-helix polypeptide are not particularly limited provided that an α-helix structure can be formed, and can be appropriately selected in accordance with the object. However, amino acids which facilitate formation of the α-helix structure are preferable. Suitable examples of such amino acids are aspartic acid (Asp), glutamic acid (Glu), arginine (Arg), lysine (Lys), histidine (His), asparagine (Asn), glutamine (Gln), serine (Ser), threonine (Thr), alanine (Ala), valine (Val), leucine (Leu), isoleucine (Ile), cysteine (Cys), methionine (Met), tyrosine (Tyr), phenylalanine (Phe), tryptophan (Trp), and the like. A single one of these amino acids may be used alone, or two or more may be used in combination.

By appropriately selecting the amino acid, the property of the α-helix polypeptide can be changed to any of hydrophilic, hydrophobic, and amphiphilic. In the case in which the α-helix polypeptide is to be made to be hydrophilic, suitable examples of the amino acid are serine (Ser), threonine (Thr), aspartic acid (Asp), glutamic acid (Glu), arginine (Arg), lysine (Lys), asparagine (Asn), glutamine (Gln), and the like. In the case in which the α-helix polypeptide is to be made to be hydrophobic, suitable examples of the amino acid are phenylalanine (Phe), tryptophan (Trp), isoleucine (Ile), tyrosine (Tyr), methionine (Met), leucine (Leu), valine (Val), and the like.

In the α-helix polypeptide, the carboxyl group, which does not form a peptide bond and which is in the amino acid which forms the α-helix, can be made to be hydrophobic by esterification. On the other hand, an esterified carboxyl group can be made to be hydrophilic by hydrolysis.

The amino acid may be any of a L-amino acid, a D-amino acid, a derivative in which the side chain portion of a L-amino acid or a D-amino acid is modified, and the like.

The number of bonds (the degree of polymerization) of the amino acid in the α-helix polypeptide is not particularly limited and may be appropriately selected in accordance with the object. However, 10 to 5000 is preferable.

If the number of bonds (the degree of polymerization) is less than 10, it may not be possible for the polyamino acid to form a stable α-helix. If the number of bonds (the degree of polymerization) exceeds 5000, vertical orientation may be difficult to achieve.

Suitable specific examples of the α-helix polypeptide are polyglutamic acid derivatives such as poly(γ-methyl L-glutamate), poly(γ-ethyl L-glutamate), poly(γ-benzyl L-glutamate), poly(n-hexyl L-glutamate), and the like; polyaspartic acid derivatives such as poly(β-benzyl L-aspartate) and the like; polypeptides such as poly(L-leucine), poly(L-alanine), poly(L-methionine), poly(L-phenylalanine), poly(L-lysine)-poly(γ-methyl L-glutamate), and the like.

The α-helix polypeptide may be a commercially available α-helix polypeptide, or may be appropriately synthesized or prepared in accordance with methods disclosed in known publications and the like.

As one example of synthesizing the α-helix polypeptide, the synthesis of block copolypeptide [poly(L-lysine)₂₅-poly(γ-methyl L-glutamate)₆₀]PLLZ₂₅-PMLG₆₀ is as follows. As is shown by the following formula, block copolypeptide [poly(L-lysine)₂₅-poly(γ-methyl L-glutamate)₆₀]PLLZ₂₅-PMLG₆₀ can be synthesized by polymerizing N^{ε}-carbobenzoxy L-lysine N^{α}-carboxy acid anhydride (LLZ-NCA) by using n-hexylamine as an initiator, and then polymerizing γ-methyl L-glutamate N-carboxy acid anhydride (MLG-NCA).

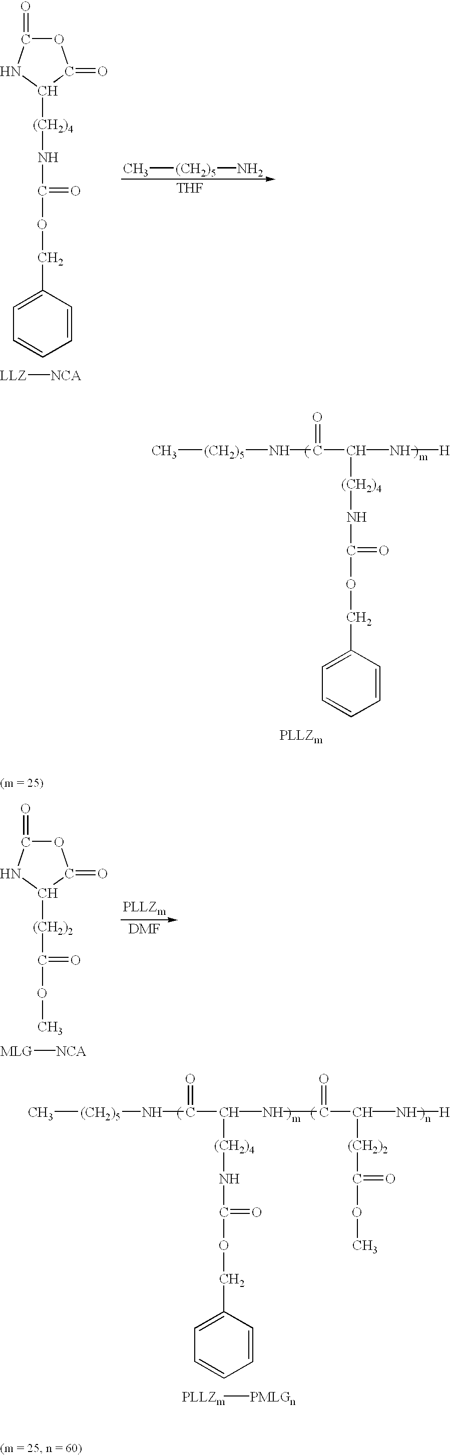

Synthesis of the α-helix polypeptide is not limited to the above-described method, and the α-helix polypeptide can be synthesized by a genetic engineering method. Specifically, the α-helix polypeptide can be manufactured by transforming a host cell by a expression vector in which is integrated a DNA which encodes the target polypeptide, and culturing the transformant, and the like.

Examples of the expression vector include a plasmid vector, a phage vector, a plasmid and phage chimeric vector, and the like.

Examples of the host cell include prokaryotic microorganisms such as E. coli, Bacillus subtilis, and the like; eukaryotic microorganisms such as yeast and the like; zooblasts, and the like.

The α-helix polypeptide may be prepared by removing the α-helix structural portion from a natural fibrous protein such as α-keratin, myosin, epidermin, fibrinogen, tropomyosin, silk fibroin, and the like.

### DNA

The DNA may be a single-stranded DNA. However, the DNA is preferably a double-stranded DNA from the standpoints that the rod-shape can be stably maintained, other substances can be intercalated into the interior of the molecule, and the like.

A double-stranded DNA has a double helix structure in which two polynucleotide chains, which are in the form of right-wound spirals, are formed so as to be positioned around a single central axis in a state in which they extend in respectively opposite directions.

The polynucleotide chains are formed by four types of nucleic acid bases which are adenine (A), thiamine (T), guanine (G), and cytosine (C). The nucleic acid bases in the polynucleotide chain exist in the form of projecting inwardly within a plane which is orthogonal to the central axis, and form so-called Watson-Crick base pairs. Thiamine specifically hydrogen bonds with adenine, and cytosine specifically hydrogen bonds with guanine. As a result, in a double-stranded DNA, the two polypeptide chains are bonded complementarily.

The DNA can be prepared by known methods such as PCR (Polymerase Chain Reaction), LCR (Ligase Chain Reaction), 3SR (Self-Sustained Sequence Replication), SDA (Strand Displacement Amplification), and the like. Among these, the PCR method is preferred.

Further, the DNA can be prepared by being directly removed enzymatically from a natural gene by a restriction enzyme. Or, the DNA can be prepared by a genetic cloning method, or by a chemical synthesis method.

In the case of a genetic cloning method, a large amount of the DNA can be prepared by, for example, integrating a structure, in which a normal nucleic acid has been amplified, into a vector which is selected from plasmid vectors, phage vectors, plasmid and phage chimeric vectors, and the like, and then introducing the vector into an arbitrary host in which propagation is possible and which is selected from prokaryotic microorganisms such as E. coli, Bacillus subtilis, and the like; eukaryotic microorganisms such as yeast and the like; zooblasts, and the like.

Examples of chemical synthesis methods include liquid phase methods or solid phase synthesis methods using an insoluble carrier, such as a tolyester method, a phosphorous acid method, and the like. In the case of a chemical synthesis method, the double-stranded DNA can be prepared by using a known automatic synthesizing device and the like to prepare a large amount of single-stranded DNA, and thereafter, carrying out annealing.

### Amylose

Amylose is a polysaccharide having a spiral structure in which D-glucose, which forms starch which is a homopolysaccharide of higher plants for storage, is joined in a straight chain by α-1,4 bonds.

The molecular weight of the amylose is preferably around several thousand to 150,000 in number average molecular weight.

The amylose may be a commercially available amylose, or may be appropriately prepared in accordance with known methods.

Amylopectin may be contained in a portion of the amylose.

The length of the rod-shaped body is not particularly limited, and may be appropriately selected in accordance with the object. However, from the standpoint of causing light reflection of the incident light as colored interference light which will be described later, a length of 810 nm or less is preferable, and 10 nm to 810 nm is more preferable.

The diameter of the rod-shaped body is not particularly limited, and is about 0.8 to 2.0 nm in the case of the α-helix polypeptide.

The entire rod-shaped body may be hydrophobic or hydrophilic. Or, the rod-shaped body may be amphiphilic such that a portion thereof is hydrophobic or hydrophilic, and the other portion thereof exhibits the opposite property of the one portion. In the case of an amphiphilic rod-shaped body, the numbers of the lipophilic (hydrophobic) portions and hydrophilic portions are not particularly limited, and may be appropriately selected in accordance with the object. Further, in this case, the portions which are lipophilic (hydrophobic) and the portions which are hydrophilic may be positioned alternately, or either type of portion may be positioned only at one end portion of the rod-shaped body.

In the case of the amphiphilic rod-shaped body, there is no particular limitation for the numbers of the moiety showing hydrophobicity and the moiety showing hydrophilicity but they may be appropriately selected according to the object. In that case, the moiety showing hydrophobicity and the moiety showing hydrophilicity may be alternately positioned. Any of the moieties may be positioned only at one end of the rod-shaped body.

### Capturing Structured Element

The capturing structured element is not particularly limited provided that it is able to capture the disease marker (or an object to be captured) and may be suitably selected according to an object.

Examples of capturing modes include, but are not limited to, physical adsorption, chemical adsorption, and the like. These modes allow formation of bonds, for example, by hydrogen bonding, intermolecular forces (van der Wals force), coordinate bonding, ionic bonding, covalent bonding, and the like.

Particular examples of the capturing structured element preferably include, host components involved in clatharate compounds (hereinafter, interchangeably referred to as “host”), antibodies, nucleic acids, hormone receptors, lectin, and physiologically active agent receptors. Among these, nucleic acids are preferred in view of easy formation of any alignment and more preferably, single-stranded DNA or single-stranded RNA is employed.

With regard to a disease marker (or an object to be captured) of such a capturing structured element, the marker or object may be a guest (component to be included) in the case of an clatharate compound, an antigen in the case of antibody, a nucleic acid, a tubulin, a chitin and the like in the case of nucleic acid, a hormone receptor in the case of hormone, sugar and the like in the case of lectin, and a physiologically active substance in the case of a physiologically active agent receptor.

### Clatharate Compound

The clatharate compound is not particularly limited provided that it possesses molecular recognizing ability (host-guest binding ability) and may be appropriately selected according to an object. Preferable examples of such clatharate compounds include the ones having tubular (one-dimensional) hollows, or layer-shaped (two-dimensional) hollows, or cage-shaped (three-dimensional) hollows, and the like.

Examples of the clatharate compound having the tubular (one-dimensional) hollow are, urea, thiourea, deoxycholic acid, dinitrodiphenyl, dioxytriphenylmethane, triphenylmethane, methylnaphthalene, spirochroman, PHTP (perhydrotriphenylene), cellulose, amylose, cyclodextrin (where the hollow is cage-shaped in a solution), phenylboric acid, and the like.

Examples of an object to be captured (the guest) by the urea, may be n-paraffin derivatives, and the like.

Examples of an object to be captured (the guest) by the thiourea, may be branched or cyclic hydrocarbons and the like.

Examples of an object to be captured (the guest) by the deoxycholic acid, may be paraffins, fatty acids, aromatic compounds, and the like.

Examples of an object to be captured (the guest) by the dinitrodiphenyl, may be diphenyl derivatives, and the like.

Examples of an object to be captured (the guest) by the dioxytriphenylmethane, may be paraffins, n-alkenes, squalene, and the like.

Examples of an object to be captured (the guest) by the triphenylmethane, may be paraffins, and the like.

Examples of an object to be captured (the guest) by the methylnaphthalene, may be C₁₆ or lower n-paraffins, branched paraffins, and the like.

Examples of an object to be captured (the guest) by the spirochroman, may be paraffins, and the like.

Examples of an object to be captured (the guest) by the PHTP (perhydrotriphenylene), may be chloroform, benzene, various high-molecular substances, and the like.

Examples of an object to be captured (the guest) by the cellulose, may be H₂O, paraffins, CCl₄, dyes, iodine, and the like.

Examples of an object to be captured (the guest) by the amylose, may be fatty acids, iodine, and the like.

The cyclodextrin is a cyclic dextrin which is formed by degradation of starch using amylase and three types are presently known. Namely, α-cyclodextrin, β-cyclodextrin and γ-cyclodextrin. In the present invention, the cyclodextrin includes cyclodextrin derivatives where a part of the hydroxyl groups thereof are substituted with an other functional group such as, for example, an alkyl group, an allyl group, an alkoxy group, an amide group, a sulfonic acid group, and the like.

Examples of an object to be captured (the guest) by the cyclodextrin, may be phenyl derivatives such as thymol, eugenol, resorcinol, ethylene glycol monophenyl ether, 2-hydroxy-4-methoxybenzophenone, and the like, benzoic acid derivatives and esters thereof such as salicylic acid, methyl p-hydroxybenzoate, ethyl p-hydroxybenzoate, and the like, steroids such as cholesterol, and the like, vitamins such as ascorbic acid, retinol, tocopherol, and the like, hydrocarbons such as limonene, and the like, allyl isothiocyanate, sorbic acid, iodine molecule, Methyl Orange, Congo Red, potassium 2-p-toluidinylnaphthalene-6-sulfonate (TNS), and the like.

Examples of an object to be captured (the guest) by the phenylboric acid, may be glucose, and the like.

Examples of a layered (two-dimensional) clatharate compound, may be clay minerals, graphite, smectite, montmorillonite, zeolite, and the like.

Examples of an object to be captured (the guest) by the clay mineral, may be hydrophilic substances, polar compounds, and the like.

Examples of an object to be captured (the guest) by the graphite, may be O, HSO₄⁻, halogen, halide, alkaline metal, and the like.

Examples of an object to be captured (the guest) by the montmorillonite, examples thereof include rucine, codeine, o-phenylenediamine, benzidine, piperidine, adenine, guianine and liposide thereof, and the like.

Examples of an object to be captured (the guest) by the zeolite, include H₂O, and the like.

With regard to the cage-shaped (three-dimensional) clatharate compound, examples thereof include hydroquinone, gaseous hydrate, tri-o-thymotide, oxyflavan, dicyanoammine nickel, cryptand, calixarene, crown compound, and the like.

Examples of an object to be captured (the guest) by the hydroquinone, may be HCl, SO₂, acetylene, rare gas elements, and the like.

Examples of an object to be captured (the guest) by the gaseous hydrate, may be halogen, rare gas elements, lower hydrocarbons, and the like.

Examples of an object to be captured (the guest) by the tri-o-thymotide, may be cyclohexane, benzene, chloroform, and the like.

Examples of an object to be captured (the guest) by the oxyflavan, may be organic bases, and the like.

Examples of an object to be captured (the guest) by the dicyanoammine nickel, may be benzene, phenol, and the like.

Examples of an object to be captured (the guest) by the cryptand, may be NH₄⁺, various metal ions, and the like.

The calixarene is a cyclic oligomer where a phenol unit synthesized from phenol and formaldehyde under a suitable condition is bonded to a methylene unit and its 4- to 8-nuclear substances are known. Among them, examples of an object to be captured (the guest) by the p-tert-butylcarixarene (n=4) may include, chloroform, benzene, toluene, and the like, examples of an object to be captured (the guest) by the p-tert-butylcarixarene (n=5) may include, isopropyl alcohol, acetone, and the like, examples of an object to be captured (the guest) by the p-tert-butylcarixarene (n=6) may include, isopropyl alcohol, acetone, and the like, chloroform, methanol, and the like, and examples of an object to be captured (the guest) by the p-tert-butylcarixarene (n=7) may include, chloroform, and the like.

The crown compounds include a macro cyclic compound having not only a crown ether having oxygen as an electron-donating donor atom but also donor atoms such as nitrogen, sulfur, and the like as an analog thereof as constituting elements for a ring structure, and also include a multicyclic crown compound comprising two or more rings represented by cryptand for example, cydohexyl-12-crown4, dibenzo-14-crown-4, tert-butylbenzo-15crown-5, dibenzo-18crown-6, dicyclohexyl-18-crown-6, 18-crown-6, tribenzo-18-crown-6, tetrabenzo-24-crown-8, dibenzo-26-crown-6, and the like.

Examples of an object to be captured (the guest) by the crown compound, may be various metal ions such as alkaline metals (e.g., Li, Na and K) and alkaline earth metals (e.g., Mg and Ca), NH₄⁺, alkylammonium ion, guanidium ion, aromatic diazonium ion, and the like and the crown compound forms a complex therewith. Examples of an object to be captured (the guest) by the crown compound, may further include polar organic compounds having a C—H (acetonitrile, malononitrile, adiponitrile, and the like), an N—H (aniline, aminobenzoic acid, amide, sulfamide derivative, and the like) and an O—H (phenol, acetic acid derivative, and the like), unit where acidity is relatively high and the crown compound forms a complex therewith.

The size (or the diameter) of the hollow of the clatharate compound is not particularly limited and may be suitably selected according to an object. However, from a standpoint of achieving stable molecular recognizing ability (host-guest binding ability), 0.1 nm to 2.0 nm in diameter is preferred.

A mixing rate (molar ratio) of the clatharate compound (host) to the guest cannot be determined at a fixed rate, and may differ according to the type of the clatharate compound and the type of the guest. However usually the rate (clatharate compound):(guest component) is from 1:0.1 to 1:10 and, preferably, from 1:0.3 to 1:3.

### Antibody

An antibody specifically bonded to the target antigen in this application refers to an antibody which specifically carries out an antigen-antibody reaction with the target antigen and it may either be a polyclonal antibody or a monoclonal antibody. It is also possible to use Fab′, Fab, F(ab′)₂, and the like of IgG, IgM, IgE and IgG.

There is no specific limitation for the source of the antibody and it may be prepared by a conventional method such as those disclosed in, for example, Jikken Seibutsugaku Koza 14, Men-eki Seibutsugaku, edited by Shigeru Muramatsu, et al. (Maruzen Co., Ltd., 1985), Zoku Seikagaku Jikken Koza 5, Men-eki Seikagaku Kenkyuho, edited by Biochemical Society of Japan (Tokyo Kagaku Dojin, 1986), Shin Seikagaku Jikken Koza 12, Bunshi Men-ekigaku III, Kogen, Kotai, Hotai, edited by Biochemical Society of Japan (Tokyo Kagaku Dojin, 1992), and the like.

More concretely, an antigen is administered to mammals such as horse, cattle, sheep, rabbit, goat, rat, mouse, and the like, and the resulting immunized antiserum and ascites may be used by itself or after purifying by known methods such as salting out (e.g., precipitating method with ammonium sulfate), gel filtration using Sephadex and the like, ion-exchange chromatographic method, electrophoresis method, dialysis, ultra filtration method, affinity chromatographic method, high-performance chromatographic method, and the like.

Further, from the viewpoint of improving specificity, a method which utilizes monoclonal antibody formed by a hybrid cell (hybridoma) obtained from myeloma cell and a spleen cell of mammals (such as mouse) immunized by antigen and the like, is preferred as substance which specifically bonds to specific component, or by using a mimetic specific component when the specific component is a specific antibody, formed by modifying the monoclonal antibody.

The monoclonal antibody may be a monoclonal antibody which is prepared by utilizing a cell fusion technique using mouse myeloma cells disclosed, for example, by Kohler and Milstein (Kohler, G. and Milstein, C., Nature, 256, 495 (1975)). The monoclonal antibody may be selected those known or commercially available.

The antibody may be prepared by a gene recombination technique, and each of the fractions such as IgG, IgM, IgA, IgE and IgD may be used. Moreover, these enzymes may be treated with enzymes such as trypsin, papain or pepsin and may be used as antibody fragments such as Fab, Fab′ or F(ab′)₂. Further, such an antibody may be used alone or in a combination of antibodies.

A target antigen is not limited and may be suitably selected according to an object, with preference to those which carries out an antigen-antibody reaction specifically with the antigen, and preferably at least one member selected from, for example, plasma protein, lipoprotein, glycoprotein, polypeptide, lipid, polysaccharide, lip polysaccharide, nucleic acid and drug. Among these, plasma proteins, tumor markers, apoprotein, virus antigens, autoantibodies, coagulation/fibrinolysis factor, hormones, drug in blood or HLA antigen are preferred. It is not necessary for the target antigen to be an antigen of the final target in the detection for each object as mentioned above but may be an antigen which co-exist with an antigen which is the final target in the detection.

Examples of the plasma protein include immunoglobulin (IgG, IgA, IgM, IgD, IgE, and the like), complement component (C3, C4, C5, C1q, and the like), CRP, α₁-antitrypsin, α₁-microglobulin, β₂-microglobulin, haptoglobin, transferrin, ceruloplasmin, ferritin, and the like.

Examples of the tumor maker include a-fetoprotein (AFP), carcinoembryonic antigen (CEA), CA 19-9, CA 125, CA 15-3, SCC antigen, prostatic acidic phosphatase (PAP), PIVKA-II, γ-seminoprotein, TPA, elastase I, neuro-specific enolase (NSE), immunosuppressive acidic protein (IAP), and the like.

Examples of the apoprotein, includes apo A-I, apo A-II, apo B, apo C-II, apo C-III, apo E, and the like.

Examples of the virus antigen include antigens related to hepatitis B virus (HBV), antigens related to hepatitis C virus (HCV), HTLV-I, HIV, hydrophobia virus, influenza virus, rubella virus, and the like.

Examples of the HCV-related antigen include HCVc100-3 recombinant antigen, pHCV-31 recombinant antigen, pHCV-34 recombinant antigen, and the like and mixtures thereof. Examples of the HIV-related antigen include virus surface antigens, and the like, such as, HIV-I env. gp 41 recombinant antigen, HIV-I env. gp 120 recombinant antigen, HIV-I gag. p 24 recombinant antigen, HIV-II env. p 36 recombinant antigen, and the like.

Examples of the infectious disease other than by virus include MRSA, ASO, toxoplasma, mycoplasma, STD, and the like.

Examples of the autoantibody include anti-microsome antibody, anti-thyroglobulin antibody, antinuclear antibody, rheumatism factor, anti-mitochondria antibody, myelin antibody, and the like.

Examples of the coagulation/fibrinolysis factor include fibrin degraded product (FDP), plasminogen, α₂-plasmin inhibitor, antithrombin III, β-thromboglobulin, factor VIII, protein C, protein S, and the like.

Examples of the hormone includes pituitary hormone (LH, FSH, GH, ACTH, TSH and prolactin), thyroid hormone (T₃, T₄ and thyroglobulin), calcitonin, parathyroid hormone (PTH), adrenocortical hormone (aldosterone and cortisol), sex gland hormone (hCG, estrogen, testosterone and hPL), pancreaticogastrointestinal gland hormone (insulin, C-peptide, glucagon and gastrin) and others (renin, angiotensins I and II, enkephalin and erythropoietin).

Examples of the drug in blood includes antiepileptic agent such as carbamazepine, primidone and valproic acid; agents for circulatory diseases such as digoxin, quinidine, digitoxin and theophylline; antibiotics such as gentamicin, kanamycin and streptomycin; and the like.

Examples of the sample to be examined containing such target antigen include pathogenic organisms such as bacteria and viruses; blood, saliva, disease tissue pieces, and the like, separated from living organism and excrement such as feces and urine. Further, when diagnosis before birth is carried out, cells of a fetus existing in amniotic fluid and a part of divided ovules may be also used as a sample to be examined. Furthermore, such a sample to be examined may be used either directly or, if necessary, after concentrating as a precipitate by a centrifugal operation and the like, and then subjected to a cytocidal treatment such as, for example, enzymatic treatment, thermal treatment, surfactant treatment, ultrasonic treatment or a combination thereof.

The antigen used in the present invention may also be produced by a gene recombination method or is chemically synthesized on the basis of a gene sequence or a peptide sequence determined by gene recombination. Thus, it is a recombinant antigen which is prepared by such a manner that an already-known genome sequence or DNA sequence obtained by a molecular cloning from natural virus or cell by utilization of gene recombination technique is treated with enzymes and the like, or subjected to chemical synthesis and the resulting DNA sequence or modified DNA sequence is expressed by a microbe, animal, plant, insect and the like, to give a recombinant antigen or it is a peptide or a modified peptide which is prepared by means of a peptide chemical synthesis known as a liquid phase method or a solid phase method utilizing the above information. A solid phase synthetic method for peptide may be preferably carried out by an automated peptide synthetic apparatus.

A preferred example of the disease marker is a disease maker which exists in at least one member selected from urine, blood, feces, lymph and other body fluids which are excrement after the food taken from daily meals by the human body is finally digested and nutrition is absorbed therefrom. It is not necessary that the disease marker is the final target substance for the detection but may be a substance which co-exists with the final target substance of detection.

Examples of the disease marker contained in the urine include protein, urinary sugar, urea, uric acid, urobilinogen, vanillylmandelic acid, hydroxyindoleacetic acid, uroporphyrin, coproporphyrin, calcium, sodium, potassium, chlorine, phosphorus, creatinine, amylase, hydroxycorticosteroid, ketosteroid, adrenaline, noradrenaline, pH, specific gravity, and the like.

Examples of the marker contained in the blood, include protein, albumin, sugar, Na, K, Cl and other electrolytes, uric acid, cholesterol, neutral fat, plasma protein, tumor marker, apoprotein, virus, autoantibody, coagulation/fibrinolysis factor, hormone, drug in blood, HLA antigen, and the like.

Examples of the disease marker contained in the feces, include protein, bilirubin, urobilinogen, blood, and the like.

The agent for health inspection of the present invention is obtained by bonding the rod-shaped body and the capturing structured element having an ability to recognize the disease marker.

The bonding method may be appropriately selected according to the capturing structured element and the rod-shaped body, known methods such as a method where a covalent bond such as an ester bond or an amide bond is utilized, a method where protein is labeled with avidin and is bonded to a biotinated capturing structured element, a method where protein is labeled with streptoavidin and is bonded to a biotinated capturing structured element, and the like.

Examples of the covalent bond method include, peptide method, diazo method, alkylation method, cyan bromide activation method, bonding by a cross-linking reagent, immobilization utilizing Ugi reaction, immobilization utilizing a thiol-disulfide exchange reaction, Schiff base formation method, chelate bonding method, tosyl chloride method, biochemically specific bonding method, and the like. For more stable bonding such as covalent bonding, preferably a reaction of thiol group with maleimide group, reaction of pyridyl disulfide group with thiol group, reaction of pyridyl disulfide group with thiol group, reaction of amino group with aldehyde group, and the like may be utilized and known methods, methods simply carried out by those skilled in the art, and modified methods thereof may be utilized. Among them, a chemically bonding agent and a cross-linking agent may form a more stable bonding.

For such chemically bonding agent and cross-linking agent, examples include carbodiimide, isocyanate, diazo compound, benzoquinone, aldehyde, periodic acid, maleimide compound, pyridyl disulfide compound, and the like. For the preferred reagent, examples include glutaraldehyde, hexamethylene diisocyanate, hexamethylene diisothiocyanate, N,N′-polymethylenebisiodoacetamide, N,N′-ethylenebismaleiimide, ethylene glycol bissuccinimidyl succinate, bisdiazobenzidine, 1-ethyl-3(3-dimethylaminopropyl) carbodiimide, succinimidyl 3-(2-pyridylthio) propionate (SPDP), N-succinimidyl 4-(N-maleimidomethyl) cyclohexane-1-carboxylate (SMCC), N-sulfosuccinimidyl 4-(N-maleimidomethyl) cyclohexane-1-carboxylate, N-succinimidyl (4-iodoacetyl) aminobenzoate, N-succinimidyl 4(1-maleimidophenyl) butyrate, iminothiolane, S-acetylmercaptosuccinic acid anhydride, methyl-3(4′-dithiopyridyl) propionimidate, methyl-4-mercaptobutyryl imidate, methyl-3mercaptopropionimidate, N-succinimidyl-S-acetyl mercaptoacetate, and the like.

### Agent for Health Inspection

In the agent for health inspection, when the object to be captured is captured by the capturing structured element, physical properties of the agent for health inspection such as refractive index and transmittance of light, mass, viscoelasticity, and the like change and, therefore, when the change is detected, it may be utilized for the detection of the captured object. The above method for the detection may be appropriately selected according to the object and, for example, various methods such as that color change is observed by naked eye, that wavelength change is detected by spectrophotometer, that oscillation of frequency of quartz oscillator, surface acoustic wave (SAW) element and the like is detected by a frequency counter, and the like may be carried out.

The agent for health inspection may be used alone, and in that case, when it is used by aligning in single or plural layer(s) on the surface of a solvent containing the subject to be captured or at the boundary between the solvent and a liquid having a reverse affinity to the solvent is preferred, since changes in wavelength may easily be detected.

It is also possible to form in a film like manner such as monomolecular film or two layered molecular films on a substrate which is vertically aligned by, for example, a Langmuir-Brodgett (LB) technique.

As shown in FIG. 1, the agent for health inspection of the present invention is used by being added to an object to be examined and has a rod-shaped body 1 and a capturing structured element 2 which specifically captures, by bonding to the rod-shaped body 1, a disease marker contained in the specimen solution. This agent for health inspection may be used alone but it is preferably used by forming into a form of film such as a monomolecular film or two layered molecular films on a substrate which is vertically aligned by a Langmuir-Brodgett (LB) method and the like.

With regard to the agent for health inspection of the present invention, an agent which is able to reflect the incident light as colored interference light is preferred from a viewpoint of recognition and discrimination.

The light reflection of the incident light as colored interference light is a color forming generated on the basis of a multi-layer thin film interference theory which is a basic principle for color formation of scaly powder of the wings of a Morpho butterfly and is a color formation on the film as a result of reflection of light of specific wavelength corresponding to the thickness of the film and the refractivity thereof when stimulation from outside such as an electric field, a magnetic field, heat, light (for example, natural light, infrared light and ultraviolet light), and the like is applied to the film. The color tone may be freely controlled like the surface skin of chameleon by the stimulation from outside.

The principle of the light reflection of the incident light as colored interference light will be described hereinafter.

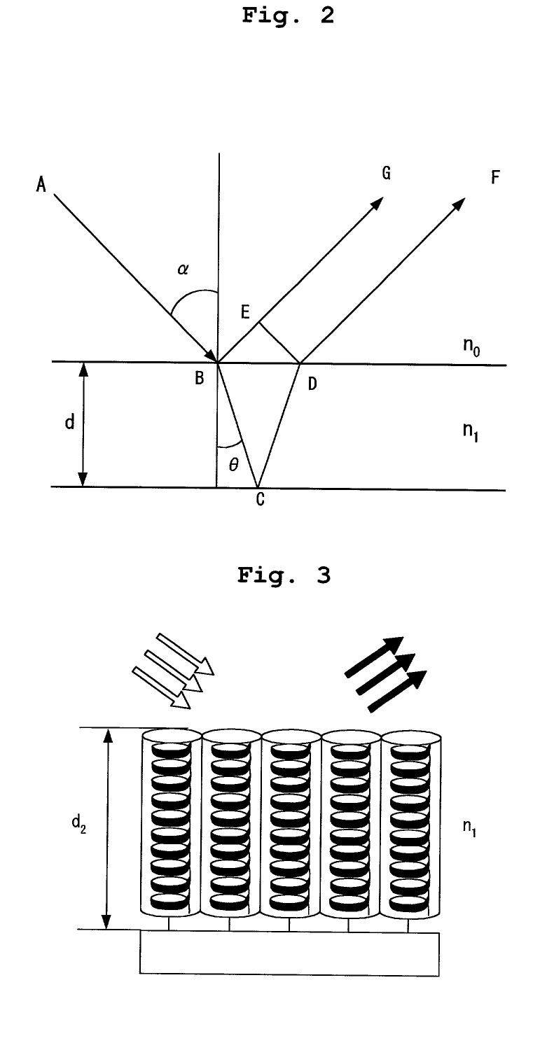

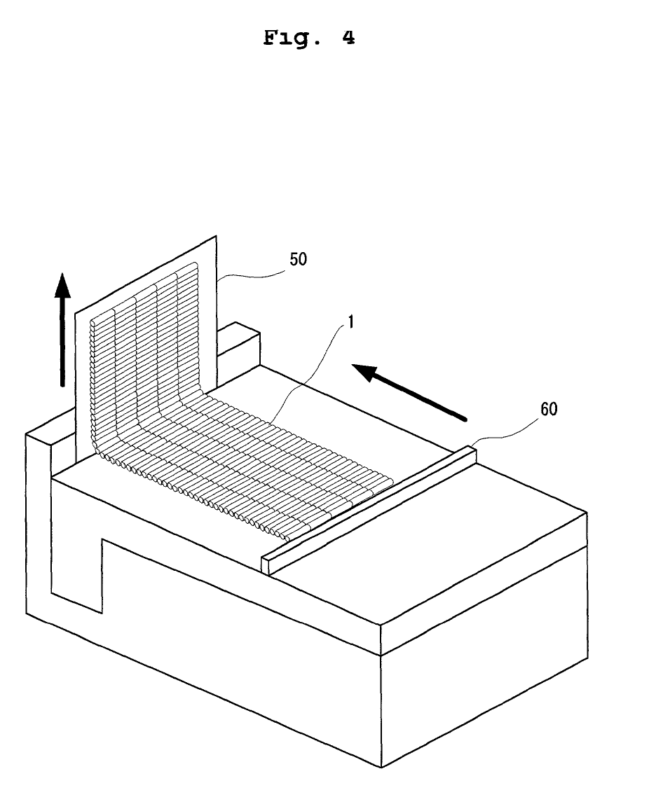

As shown in FIG. 2 and FIG. 3, when light is irradiated on the film of the rod-shaped body, the wavelength (λ) of the interference light reflected by the film is emphasized under the condition as shown in the following (1) and enfeebled under the condition as shown in the following (2).

$$\begin{matrix}λ = \frac{2 tl}{m} \sqrt{{n}^{2} - {sin}^{2} α} & ( 1 ) \\ λ = \frac{4 tl}{2 m - 1} \sqrt{{n}^{2} - {sin}^{2} α} & ( 2 )\end{matrix}$$

In the formulae (1) and (2), λmeans wavelength (nm) of the interference light, α means angle of incidence (degree) of the light to the film, t means thickness (nm) of a single film, 1 means number of layers in the film, n means the refractive index of the film and m means an integer of 1 or more.

The thickness of a single film is preferably 810 nm or less and, more preferably, it is from 10 nm to 810 nm.

When the thickness is appropriately changed, the color (wavelength) of the light reflected as colored interference light may be changed.

The film may be either a monomolecular film or a layered film comprising the monomolecular film.

The monomolecular film or the layered film comprising the monomolecular film may be formed by, for example, a Langmuir-Brodgett method (LB method) and, in that case, a known LB film forming apparatus (such as NL-LB 400 NK-MWC manufactured by Nippon Laser & Electronics Laboratories) may be used.

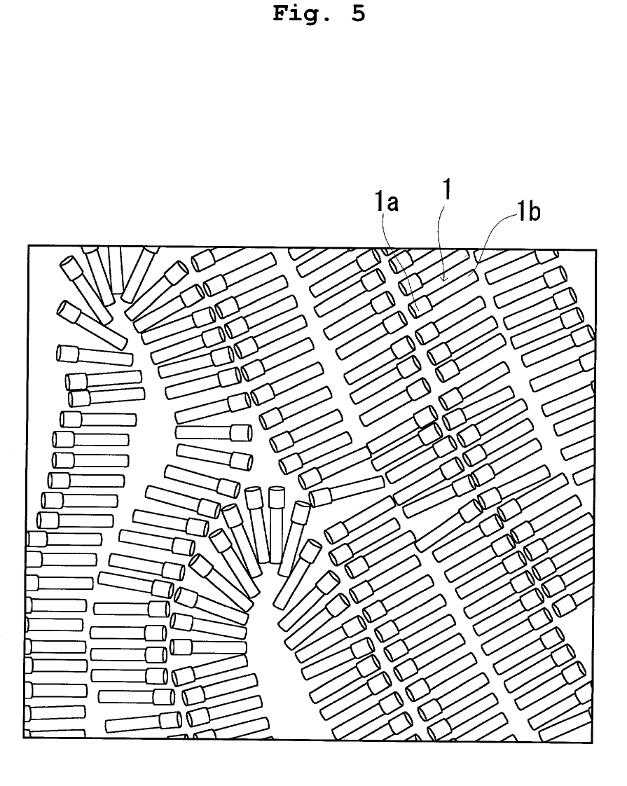

Formation of the monomolecular film may be carried out, for example, in such a state that the above mentioned rod-shaped body which is lipophilic (hydrophobic) or amphiphilic is floated on a water surface (on an aqueous phase) or in such a state that the rod-shaped body which is lipophilic (hydrophobic) or amphiphilic is floated on an oil surface (on an oil phase) or, in other words, the rod-shaped body 1 is aligned as shown in FIG. 4 so as to form a film on a substrate 50 using an pushing material 60. When such an operation is repeatedly carried out, the layered film where the monomolecular films are layered in any number may be formed on the substrate 50. Incidentally, it is preferred that the monomolecular film or the layered film is fixed on the substrate 50 so that the light reflection as colored interference light by the monomolecular film or layered film is expressed in a stable manner.

In that case, there is no particular limitation for the substrate 50 and, according to the object, its material, shape, size, and the like may be appropriately selected although it is preferred that its surface is appropriately subjected to a surface treatment previously so that the rod-shaped body 1 is easily adhered or bonded thereto. When the rod-shaped body 1 (such as α-helix polypeptide) is hydrophilic for example, it is preferred that a surface treatment such as hydrophilizing treatment using octadecyl trimethylsiloxane and the like is previously carried out.

With regard to the state where the rod-shaped body is floated on an oil phase or an aqueous phase in the formation of the monomolecular film of the amphiphilic rod-shaped body, the lipophilic areas (hydrophobic areas) 1a of the rod-shaped body 1 are aligned in an adjacent state each other on the aqueous phase or oil phase while the hydrophilic areas 1b are aligned in an adjacent state each other as shown in FIG. 5.

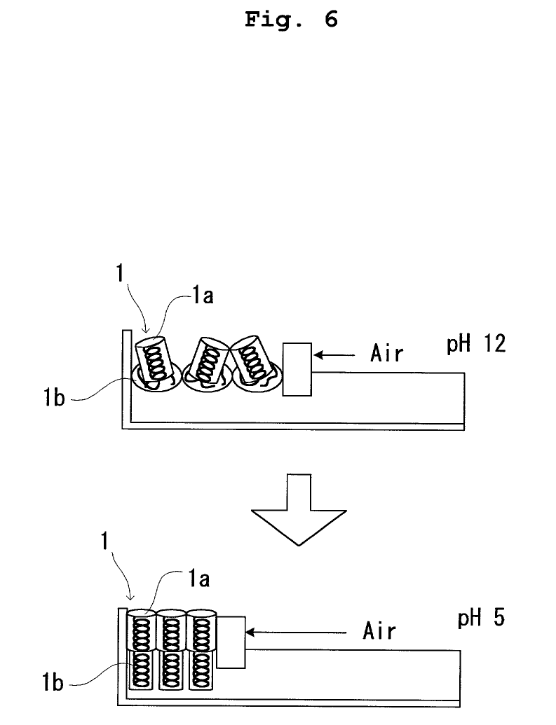

The above is an example of a layered membrane or a layered film comprising the film where the long axes of the rod-shaped body in the agent is aligned parallel to each other in the plane direction of the monomolecular film (in a horizontal state) while a monomolecular film where the rod-shaped body is aligned in the thickness direction of the monomolecular film (in a vertical state) may be manufactured, for example, as follows. First, as shown in FIG. 6, water (aqueous phase) is made alkaline of around pH 12 under such a state that the amphiphilic rod-shaped body 1 (α-helix polypeptide) is floated on the water surface (aqueous phase) (i.e., in a horizontal state). As a result, in the hydrophilic area 1b in the rod-shaped body 1 (α-helix polypeptide), the α-helix structure thereof is disentangled to give a random structure. At that time, the lipophilic area (hydrophobic area) la of the rod-shaped body 1 (α-helix polypeptide) maintains its α-helix structure. Then, the pH of the water (aqueous phase) is made acidic to about 5 thereby the hydrophilic area 1b in the rod-shaped body 1 (α-helix polypeptide) forms an α-helix structure m again. When the pushing material attached to the rod-shaped body 1 (α-helix polypeptide) is pushed by the pressure of air from its side to the rod-shaped body 1 (α-helix polypeptide), the rod-shaped body 1 maintains vertical against water (aqueous phase) while its hydrophilic area 1b forms an α-helix structure in the direction substantially orthogonal to the water surface in the aqueous phase. When the aligned rod-shaped body 1 (α-helix polypeptide) is pushed out onto the substrate 50 using a pushing material 60 as mentioned above by referring to FIG. 4, it is possible to form a monomolecular film on the substrate 50. When such operation is repeatedly carried out, the layered film having a prescribed number of monomolecular films may be formed on the substrate 50.

Examples of the agent for health inspection having a single layer or laminated layers which may reflect incident light as colored interference light could be an amphiphilic agent for health inspection, and preferably the rod-shaped body is α-helix polypeptide.

The agent for health inspection of the present invention may be an agent which precipitates or forms a gel when a disease marker is captured.

Although the method of use of the agent for health inspection of the present invention is not particularly limited, the agent for health inspection is added to a sample containing the specimen which is subjected to a pretreatment if necessary and then changes in color tone of the light reflection of the incident light as colored interference light or changes in wavelength caused by a specific capture of the disease marker by the capturing structured element of this agent for health inspection is measured whereby the presence of the disease marker in the sample may be examined quickly with high sensitivity.

In addition, changes in color tone of the light reflection of the incident light as colored interference light or changes in wavelength when the agent for health inspection is fixed on a substrate such as paper, plastic and the like followed by dipping the substrate into the solution to be examined may be measured. Incidentally, in the agent for health inspection of the present invention, it is preferred that a stable emulsion is added to a waste liquid and the like whereby the changes in color tone or changes in wavelength are measured.

In the case of blood, it is possible to use a serum prepared by centrifugation after collection of blood as a sample to be examined. In the case of feces, it is possible to use that which is diluted with a predetermined amount of physiological saline followed, if necessary, by filtering as a sample to be examined.

To be specific, in a western style bathroom at home, changes in color tone by light reflection of the incident light as colored interference light when a predetermined amount of the agent for health inspection which is aligned in a film-like shape is added to urine excreted to the toilet may be confirmed by naked eye. When a material having a crown ether compound as the capturing structured element is bonded to the rod-shaped body is used as the capturing structured element of the agent for health inspection in that case, the presence of electrolytes in the urine such as Na, K, Cl, P, Ca, and the like may be confirmed.

Further, when cyclodextrin is used as a capturing structured element bonded to the rod-shaped body of the agent for health inspection, the presence of sugar, protein, and the like in the urine may be confirmed.

Still further, when anti-human albumin antibody is used as a capturing structured element bonded to the rod-shaped body of the agent for health inspection, the amount of albumin in the urine may be measured.

Furthermore, when plasma protein, tumor marker, apoprotein, virus, autoantibody, coagulation/ fibrinolysis factor, hormone, drug in blood or antibody to HLA antigen are used as capturing structured element bonded to the rod-shaped body of the agent for health inspection, such a component in a small amount of blood may be precisely measured.

Incidentally, in the agent for health inspection of the present invention, state of health may be precisely observed when measurement is carried out at a predetermined time every day and the elapse of the result of examination during a predetermined period is confirmed.

### Health Inspection Apparatus

The health inspection apparatus in accordance with the first aspect of the present invention omprises a rod-shaped body having a length of 810 nm or less and a capturing structured element specifically capturing, by bonding to the rod-shaped body, a disease marker contained in the specimen solution. The apparatus also comprises an agent for health inspection reflecting the incident light as colored interference light by aligning in a film-like shape and is provided with an adding means for contacting the agent for health inspection to a sample to be examined and a wavelength measuring means for measuring the change in the wavelength by the light reflection of the incident light as colored interference light of the above film like agent for health inspection which captures the disease marker.

There is no particular limitation for the sample to be examined so long as it could be an object of the examination containing the disease marker for example, blood, urine, and the like.

With regard to the adding means, there is no particular limitation so far as it is a means for adding a predetermined amount of the agent for health inspection to the sample to be examined or it is a means for adding a predetermined amount of the sample to be examined to the agent for health inspection. It is preferred however that the amount of the agent for health inspection is made to such an extent that the light reflection of the incident light as colored interference light may be easily detected by aligning in a film-like shape.

One of the preferred aspects of the health inspection apparatus is an aspect in which the agent for health inspection is amphiphilic and the adding means is a means for adding the agent for health inspection and the oil phase thereof into an aqueous sample and for bringing the agent for health inspection to contact the sample.

In that case, the agent for health inspection is amphiphilic in which the agent for health inspection is aligned vertically to comprise a form of film at the interface between the oil phase and the aqueous phase and, therefore, it is preferred because changes in wavelength caused by the light reflection of the incident light as colored interference light are easily measured.

The health inspection apparatus in accordance with the second aspect of the present invention is provided with: a biosensor where the agent for health inspection of the present invention is adhered and bonded in a film-like shape to a quartz oscillator or a surface acoustic wave (SAW) element; an oscillation circuit where changes in mass or changes in viscoelasticity when the disease marker is captured by the biosensor are oscillated as a frequency; and a frequency counter where the frequency of the oscillation oscillated from the oscillation circuit is measured.

In that case, it is preferred that the agent for health inspection is adhered and bonded in a monomolecular form of film to the quartz oscillator or to the surface acoustic wave (SAW) element or is adhered and bonded in a bimolecular form of film thereto. With regard to the frequency counter, there is no particular limitation so far as it is able to precisely measure the frequency from the quartz oscillator or the surface acoustic wave (SAW) element.

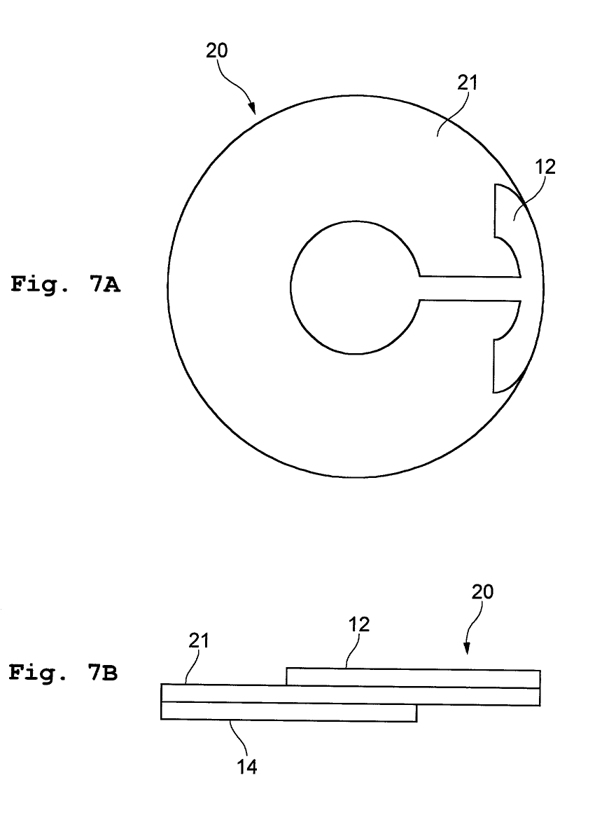

In the quartz oscillator, metal electrodes are vapor deposited on the surface and the back of a thin quartz plate. An example of the quartz oscillator 20 is shown in FIG. 7A and 7B. FIG. 7A is a plane view while FIG. 7B is a front view. An electrode 12 is vapor deposited on the surface of the quartz plate 21 while another electrode 14 is vapor deposited on the back thereof. The electrodes extend to the left side from the electrodes 12, 14 and the left ends thereof are connected to clip-type lead wires (not shown) followed by connecting to an alternating current source (not shown). When alternating current is applied between the electrodes 12, 14, there is generated oscillation of a predetermined period in the quartz plate 21 due to a back piezoelectric effect.

On the surface of the quartz oscillator 20, there is adhered and bonded an agent for health inspection film (not shown). The capturing bonding material of this agent for health inspection film captures the disease marker and the mass of the surface of the quartz oscillator 20 changes corresponding to the mass of the captured diseases marker whereby the resonance frequency changes.

Between the changes in the resonance frequency and changes in the mass of the agent for health inspection film coated on the surface of the quartz oscillator 20 which oscillates in parallel to the plane vertical to the thickness direction, there is a relation as shown in the following formula (3) whereby changes in the mass may be detected from changes in the resonance frequency. For example, in the case of an oscillator of resonance frequency of 9 MHz (area: about 0.5 cm²), a reduction in frequency of 400 Hz is resulted by an increase in mass of 1 μg.

ΔF =−2.3×10⁶(F²ΔW/A) (3)

In the formula, F means resonance frequency (MHz) of the quartz oscillator, ΔF means changes (Hz) in the resonance frequency by changes in mass, ΔW means changes in mass (g) of the film and A means the surface area (cm²) of the film.

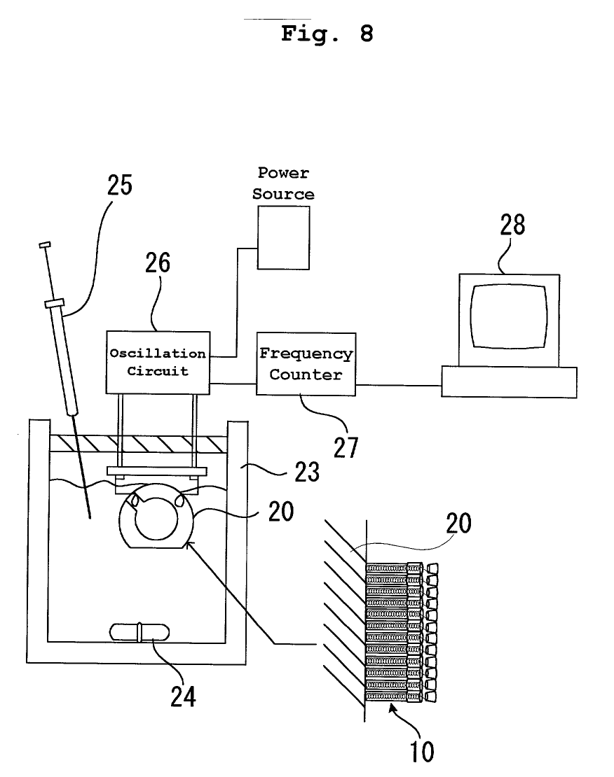

An example of the health inspection apparatus is shown in FIG. 8. The quartz oscillator 20 (agent for health inspection 10 is bonded on the surface in a film-like shape) is attached to an arm for attaching the quartz oscillator and dipped in a solution in a thermostat heat block 23. The thermostat heat block 23 is to keep the temperature of the solution constant. The solution is stirred by a stirrer 24. In a sample injection 25, a sample to be measured is injected into a solution. In the oscillation circuit 26, alternating current field is applied to the electrodes 12, 14 of the quartz oscillator 20 to oscillate the quartz oscillator 20. Oscillation frequency of the oscillation circuit 26 is counted by a counter 27, analyzed by a computer 28 and the mass of the disease marker in the sample is indicated.

The disease marker is specifically captured as such by the capturing bonding material of the agent for health inspection in which the mass of the agent for health inspection changes. The change in the mass is caught by the quartz oscillator and converted to frequency and, therefore, when the change in frequency is measured by the frequency counter, the presence or absence of the disease marker may be specifically tested.

When a calibration curve is previously prepared using a disease marker of a known amount, the disease marker concentration to be detected or quantified in the sample may be detected or quantified.

The surface acoustic wave (SAW) element is an element where a pair of comb-shaped electrodes is set on the surface of a solid and an electric signal is converted to a surface acoustic wave (sonic wave transmitting the solid surface, ultrasonic wave), transmitted to the encountering electrode and outputted as electric signal again whereby a signal of specific frequency corresponding to the stimulation may be measured. Ferroelectric a substance such as lithium tantalite and lithium niobate, quartz, zinc oxide thin film, and the like are used as the material therefor.

The SAW creates an elastic wave which transmits along the surface of the medium and exponentially decreases in the inside area of the medium. In the SAW, the transmitted energy is concentrated on the surface of the medium whereby the changes in the medium surface may be sensitively detected and, as a result of the changes in the mass of the surface, the SAW transmitting velocity changes the same as in the case of the quartz oscillator. Usually, SAW transmitting velocity is measured as the changes in oscillation frequency using an oscillation circuit. Changes in the oscillation frequency are given by the following formula.

Δf=(k₁+k₂)f²hρ−k₂f²h[(4μ/Vᵣ²)(λ+μ/λ+2μ)]

In the formula, k₁ and k₂ mean constants, h means thickness of the fixed film, ρ means density of the film, λ and μ mean Lame constants of the film and Vᵣ means a SAW transmitting velocity.

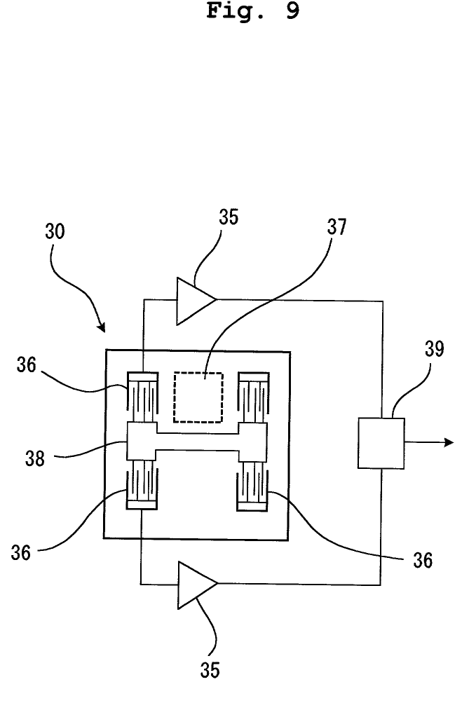

FIG. 9 is a schematic plane view which shows an example of the constitution of main parts of a surface acoustic wave (SAW) element. In FIG. 9, in the SAW element sensor 30, there are formed gold electrode 38 and comb-shaped electrodes 36 at both ends thereof on the SAW element having a resonance frequency of 90 MHz made of an ST cut quartz and there is formed a film (not shown) comprising the agent for health inspection in the surface wave transmitting region 37 as shown by dotted lines. The sensor is connected to a frequency counter 39 from each comb-shaped electrode 36 via a high-frequency amplifier 35 whereby the mass of the disease marker in the sample is indicated.

The disease marker in the sample is specifically captured by the capturing bonding material of the agent for health inspection whereby the mass or viscoelasticity of the agent for health inspection changes, the mass change or viscoelasticity change is caught by the surface acoustic wave (SAW) element and converted to a frequency and, therefore, when this frequency change is measured by the frequency counter, it is now possible to specifically examine whether or not the disease marker is present.

When a calibration curve is previously prepared using a disease marker of a known amount, the disease marker to be detected or quantified in the sample may be detected or quantified.

With regard to a method for a chemical bonding/fixing of the agent for health inspection on the electrodes of the quartz oscillator or the surface acoustic wave (SAW) element which constitutes the biosensor, there is no particular limitation and that may be appropriately selected according to the object. For example, that may be carried out by means of a chemical bond such as covalent bond.

With regard to the covalent bond method, there is no particular limitation but the same one which is used for bonding the capturing bonding material to the rod-shaped body in the agent for health inspection may be appropriately selected and used.

To be specific, there may be exemplified a method where a substance in which a thiol group is introduced into the end of the agent for health inspection is synthesized, the quartz oscillator or the surface acoustic wave (SAW) element is dipped in a solution of this substance and made to react therewith for a predetermined time and then the biosensor to which the agent for health inspection is chemically bonded/fixed is taken out from the solution followed by drying. The thiol group includes S-trityl-3-mercaptopropyloxy-β-cyanoethyl-N,N-diisopropylamino phosphoramidide and the like and introduction of the thiol group into the end of the agent for health inspection may be carried out by a phosphoramidide method.

### EXAMPLES

Hereinafter, examples of the present invention will be described although the present invention is not limited thereto.

### Example 1

Polymerization of γ-methyl-L-glutamine-N-carboxylic acid anhydride was carried out using phenylboric acid (FB) as shown by the following formula to prepare a polypeptide (PMG-FB) as shown in the following formula where FB having a molecule-recognizing ability is placed at the end of the molecular chain.

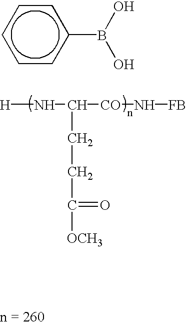

A solution of PMG-FB in DMF was developed using this polypeptide on the interface of n-hexane/water formed on a trough made of Teflon to form a monomolecular film.

The main chain secondary structure of the resulting PMG-FB molecule is evaluated by means of measurement of circular dichroism (CD) spectrum of an LB membrane accumulated on a quartz plate and, as a result, it was confirmed that, in the molecular membrane, the PMG-FB molecule has an α-helix structure.

When an aqueous solution of glucose was added using the agent for health inspection where this polypeptide was emulsified/dispersed and a change in wavelength by light reflection of the incident light as colored interference light was measured by a spectrophotometer, a significant wavelength change was noted in the polypeptide as compared with an agent for health inspection to which no phenylboric acid (FB) was bonded.

### Example 2

Polymerization of N^{ε}-carbobenzoxy L-lysine N^{α}-carboxylic acid anhydride (LLZ-NCA) was carried out using n-hexylamine as an initiator and then polymerization of γ-methyl L-glutamate N-carboxylic acid anhydride (MLG-NCA) was carried out to prepare a block copolypeptide PLLZ₂₀₀₀-PMLG₆₀₀ where the degree of polymerization of the PLLZ moiety was 2000 and that of the PMLG moiety was 600. After that, the PMLG segment was partially hydrolyzed to give L-glutamic acid (LGA) thereby an α-helix copolypeptide PLLZ₂₅₀-P(MLG₄₂₀/LGA₁₈₀) was obtained.

Avidin was introduced into this α-helix copolypeptide and a biotin-labeled human albumin antibody bonded thereto via a biotin-avidin to prepare an agent for health inspection.

After that, when the agent for health inspection was made in a state of being floated (i.e., a horizontal state) on water surface (aqueous phase), the pH of the water (aqueous phase) was made alkaline of around 12. As a result thereof, the α-helix structure in the hydrophilic moiety in the agent for health inspection was disentangled to give a random structure. At that time, the hydrophobic moiety of the agent for health inspection still maintained its α-helix structure. After that, the pH of the water (aqueous phase) was made acidic of around 5. As a result, the hydrophilic moiety of the agent for health inspection was made into the α-helix structure again. At that time, when the pushing material attached to the agent for health inspection was pushed from the side thereof by the pressure of air to the agent for health inspection, the hydrophilic moiety was made into the α-helix structure in the direction substantially orthogonal to the water surface in the aqueous phase while the agent for health inspection was still in a vertical state to the water (aqueous phase). Then, as mentioned above, when the agent for health inspection in an aligned state was pushed onto the substrate (plate) using the pushing material, it was possible to form a monomolecular film where the agent for health inspection was vertically stood on the substrate (plate). Incidentally, the above operation was carried out using an LB film forming apparatus (NL-LB 400 NK-MWC; manufactured by Nippon Laser & Electronics Laboratories). Thickness of this monomolecular film was calculated to be about 16 nm.

The resulting substrate on which the monomolecular film comprising the agent for health inspection was formed was placed in a urine sample which was positive in a protein qualitative test by a test method and changes in wavelength by light reflection as colored interference light were measured using a spectrophotometer. A significant change in the wavelength of the light reflected from the α-helix copolypeptide was observed as compared to the wavelength of light reflected from an agent for health inspection in which the human albumin antibody was not bonded.

### Example 3

The monomolecular film in which the agent for health inspection was vertically formed on the substrate (plate) in Example 2 was used as a constituting unit having two layers to prepare a substrate where the agent for health inspection was vertically placed in a two layered molecular films form. The substrate was placed in a urine sample which was positive in a protein qualitative test by a test method and changes in wavelength by light reflection as colored interference light were measured by a spectrophotometer. A significant change in wavelength was observed in the α-helix copolypeptide as compared to the agent for health inspection in which the human albumin antibody was not bonded.

### Example 4

A product in which a gold electrode having an area of 0.2 cm² and a gold-plated lead wire attached to a quartz oscillator (AT cut; area: 0.5 cm²; basic frequency: 9 MHz) was used as a quartz oscillation electrode.

The quartz oscillation electrode was dipped at room temperature for 1 hour in a 1% by volume aqueous solution of aminopropyl triethoxysilane (manufactured by Chisso) and washed by irradiation of ultrasonic wave of 20 kHz in pure water for 30 minutes to remove an excessive aminopropyl triethoxysilane. Then, the quartz oscillation electrode was subjected to a thermal treatment for 20 minutes at the temperature of 110° C. whereby a covalent bond was formed between aminopropyl triethoxysilane and the quartz oscillator surface.

The quartz oscillator was dipped for 1 hour in a 1% by volume aqueous solution of glutaraldehyde to form a covalent bond between glutaraldehyde and aminopropyl triethoxysilane and, nextly, the quartz oscillator was washed by irradiation with ultrasonic waves of 20 kHz for 30 minutes in pure water to remove excess glutaraldehyde.

The quartz oscillator electrode was dipped for 2 hours in 100 ml of phosphate buffer of pH 7.2 containing the agent for health inspection prepared in Example 2. Consequently, the agent for health inspection was fixed to the quartz oscillator via glutaraldehyde. Then, unreacted agent for health inspection was removed by washing with a phosphate buffer of pH 7.2.

After that, the quartz oscillator was attached to the health inspection apparatus as shown in FIG. 8 and placed in urine samples which were positive and negative in a protein qualitative test by a test method and changes in frequency during 10 minutes were checked. The changes in oscillation frequency nearly reached saturation within a minute.

As a result, the urine sample which was positive in the protein qualitative test by a test showed a significant reduction in oscillation frequency as compared with the urine sample which was negative in the protein qualitative test.

### Example 5

A health inspection apparatus was assembled by the same manner as in Example 4 except that a surface acoustic wave (SAW) element of ST cut having oscillation frequency of 10.3 MHz as shown in FIG. 9 was used in place of the quartz oscillator in Example 4.

It was placed in urine samples which were positive and negative in a protein qualitative test by a test method and the changes in frequency within 10 minutes were checked. Within one minute, the changes in the oscillation frequency nearly reached saturation.

As a result, the urine sample which was positive in the protein qualitative test by a test showed a significant reduction in oscillation frequency as compared with the urine sample which was negative in the protein qualitative test.

In accordance with the present invention, a person is able to judge his own state of health immediately after use in toilet and the like at home and, therefore, it is now possible to conduct a test easily and quickly in a daily life at home rather than visiting medical facilities.

what is claimed is:

1. An agent for health inspection used as an additive to the specimen solution comprising:
a rod-shaped body; and
a capturing structured element bonded to the rod-shaped body which specifically captures a disease marker in a specimen solution.

2. An agent for health inspection according to claim 1, wherein the agent for health inspection is amphiphilic.

3. An agent for health inspection according to claim 1, wherein the capturing structured element is bonded to an end of the rod-shaped body.

4. An agent for health inspection according to claim 1, wherein the capturing structured element is bonded to a circumferential side of the rod-shaped body.

5. An agent for health inspection according to claim 1, wherein the specific capture is any of a physical adsorption and a chemical adsorption.

6. An agent for health inspection according to claim 1, wherein the rod-shaped body is a helical organic molecule.

7. An agent for health inspection according to claim 6, wherein the helical organic molecule is any of α-helix polypeptide, DNA and amylose.

8. An agent for health inspection according to claim 7, wherein the agent for health inspection is amphiphilic.

9. An agent for health inspection according to claim 8, wherein the helical organic molecule is an α-helix polypeptide.

10. An agent for health inspection according to claim 8, wherein the agent for health inspection reflects an incident light as colored interference light by aligning the agent for health inspection in a film-like shape.

11. An agent for health inspection according to claim 1, wherein the length of the rod-shaped body is 810 nm or shorter.

12. An agent for health inspection according to claim 11, wherein the agent for health inspection reflects an incident light as colored interference light by aligning the agent for health inspection in a film-like shape.

13. An agent for health inspection according to claim 1, wherein the capturing structured element has an affinity to the disease marker.

14. An agent for health inspection according to claim 1, wherein the disease marker is present in at least one selected from urine, blood, feces, lymph and other body fluids.

15. An agent for health inspection according to claim 1, wherein the disease marker is a substance which coexists with a final target.

16. An agent for health inspection according to claim 1, wherein the agent for health inspection reflects an incident light as colored interference light when the disease marker is captured.

17. An agent for health inspection according to claim 1, wherein the agent for health inspection precipitates when the marker is captured.

18. An agent for health inspection according to claim 1, wherein the agent for health inspection forms a gel when the disease marker is captured.

19. A health inspection apparatus comprising:
an agent for health inspection;
means for contacting the agent for health inspection to a specimen solution; and
means for measuring a change in wavelength of a colored interference light reflected by the agent for health inspection capturing a disease marker;
wherein the agent for health inspection comprises a rod-shaped body having a length of 810 nm or less and a capturing structured element for specifically capturing a disease marker bonded to the rod shaped body and contained in a specimen solution and which reflects an incident light as colored interference light by aligning in a film-like shape.

20. A health inspection apparatus according to claim 19, wherein the agent for health inspection is amphiphilic and the specimen solution is aqueous and dispersed in an oil phase.

21. A health inspection apparatus comprising:
a biosensor which comprises one of a quartz oscillator and a surface acoustic wave (SAW) element and an agent for health inspection aligned to the one of a quartz oscillator and a surface acoustic wave (SAW) element in a film-like shape;
an oscillation circuit which oscillates one of a change in mass and a change in viscoelasticity as frequency when the biosensor captures a disease marker; and
a frequency counter which measures the frequency of the oscillation oscillated by the oscillation circuit;
wherein the agent for health inspection comprises a rod-shaped body and a capturing structured element bonded to the rod-shaped body which specifically captures a disease marker in a specimen solution and the agent for health inspection is amphiphilic.

22. A health inspection apparatus according to claim 21, wherein the agent for health inspection is aligned in a monomolecular film to one of a quartz oscillator and a surface acoustic wave (SAW) element.

23. A health inspection apparatus according to claim 21, wherein the agent for health inspection is aligned in a two layered monomolecular films to one of a quartz oscillator and a surface acoustic wave (SAW) element.
